(19) United States
(12) Patent Application Publication
(10) Pub. No.: US 2013/0048643 A1
(43) Pub. Date: Feb. 28, 2013

(54) Coolant Reservoir for an Internal Combustion Engine

(71) Applicants: David Flajnik, Rochester Hill, MI (US); Michael C. Stemm, Lapeer, MI (US); Andrew Medeiros, Brampton (CA); Babak Fana, Mississauga (CA)

(72) Inventors: David Flajnik, Rochester Hill, MI (US); Michael C. Stemm, Lapeer, MI (US); Andrew Medeiros, Brampton (CA); Babak Fana, Mississauga (CA)

(73) Assignee: Salflex Polymers Limited, Weston, ON (CA)

(21) Appl. No.: 13/515,927

(22) PCT Filed: Dec. 16, 2010
(86) PCT No.: PCT/CA10/01990

§ 371 Date: Oct. 26, 2012

Related U.S. Application Data
(60) Provisional application No. 61/287,907, filed on Dec. 18, 2009.
(60) Provisional application No. 61/364,188, filed on Jul. 14, 2010.

(51) Int. Cl. F01P 11/02; B29C 65/70; B29C 45/14

(52) U.S. Cl. 220/562; 156/245

(57) ABSTRACT

A coolant reservoir for an internal combustion engine is made from two plastic molded sections, an upper one of which is formed with an integral inlet/syphon tube that extends downwardly into the reservoir when the sections are assembled together to provide a conduit through which coolant can enter the reservoir and syphon from the reservoir without the need for a separate tube.

### CROSS-REFERENCE TO RELATED APPLICATIONS

This application claims benefit from U.S. provisional applications Nos. 61/287,907 filed Dec. 18, 2009 and 61/364,188 filed Jul. 14, 2010 which are incorporated herein by reference in their entirety.

### FIELD OF THE INVENTION

This invention relates generally to coolant reservoirs for internal combustion engines.

### BACKGROUND OF THE INVENTION

A coolant reservoir functions by providing a volume into which hot engine coolant can migrate as the coolant expands. The reservoir is connected to the engine cooling system with hoses so that the coolant can flow to the reservoir as the coolant expands and return to the cooling system as it cools and contracts. Typically, the reservoir is fitted with a syphon tube which provides an inlet from the engine cooling system and a return path to the cooling system. In extreme cases, the coolant may overflow the reservoir through an overflow outlet, from which it can be directed to another location by way of a hose.

Typically, hoses are connected to fluid reservoirs at defined points to address specific functions. The hoses and attachment points create unique concerns, increased costs and possible leak points, as well as taking up space and increasing manufacturing costs and/or difficulties.

The practice of integrating features into a molded part has been undertaken in the past in order to reduce manufacturing cost and shipping cost arising from a reduced number of components. For example, a tube may be integrated on the exterior of a blow molded component to reduce the length of the hose that has to be connected to the component. Molded features such as barbed outward projections are a routine means for attaching a tube or hose to a reservoir.

The following references were considered in the preparation of this application:
U.S. Pat. No. 7,552,839 (Padget)
U.S. Pat. No. 3,741,172 (Andreux)
U.S. Pat. No. 7,188,588 (Hewkin)
U.S. Pat. No. 4,480,598 (Berrigan)
U.S. Pat. No. 4,738,228 (Jenz, et al.)

### SUMMARY OF THE INVENTION

According to one aspect of the invention there is provided a coolant reservoir for an internal combustion engine having a cooling system, the reservoir comprising at least two plastic molded sections that are sealed together to define an internal volume for receiving coolant. The reservoir has an inlet for connection to the engine cooling system and an outlet providing an overflow. The inlet is defined by an syphon tube that extends downwardly from one of the molded sections into the internal volume, terminating adjacent to but spaced from a bottom wall of reservoir. At least a portion of the syphon tube is molded integrally with the one molded section and extends both into and outwardly of the reservoir, the syphon tube opening to the exterior of the reservoir through the one molded section.

In summary, at least a portion of the syphon tube is integrated into, normally, an upper section of the reservoir, in effect becoming a detail formation on that section. In most cases, there will be two plastic molded sections, namely the upper section and a lower section and the two sections will meet and be sealed together in a horizontal plane that extends through the reservoir. As such, when the two sections are assembled together, at least a portion of the inlet/inlet tube is already formed on the upper molded section and the reservoir is completed in one assembly step.

It has been found that a molded reservoir section with an integral inlet/syphon tube can readily be made by injection molding. In some cases, it may not be practical to mold the entire syphon tube in one piece with the reservoir section. For example, it may be practical difficulties with tooling if the height of the reservoir exceeds a certain level. It such a situation, the integrally molded portion of the syphon tube will extend a certain distance into the internal volume of the reservoir and an extension tube will be added, with or without a clamp, to bring the syphon tube to the required overall length.

The overflow outlet from the reservoir may be formed in the same way as the inlet/syphon tube and may or may not include a tubular portion that protrudes inwardly of the reservoir. An outlet of this form may be used on a reservoir with a conventional inlet.

### BRIEF DESCRIPTION OF THE DRAWINGS

In order that the invention may be more clearly understood, reference will now be made to the accompanying drawings which illustrate a number of preferred embodiments of the invention by way of example, and in which:

FIG. 1 is a vertical sectional view through a coolant reservoir in accordance with one aspect of the present invention;

FIG. 2 is a detail view of the left hand portion of the reservoir showing the inlet/syphon tube;

FIG. 3 illustrates a modification of FIG. 2 using a shorter syphon tube;

FIG. 4 is a view similar to FIGS. 2 and 3 illustrating an alternative form of inlet/syphon tube;

FIG. 5 is a perspective view of the portion of the upper molded section of the reservoir of FIG. 4, in the vicinity of the inlet/syphon tube;

FIG. 6 is a perspective view of a coolant reservoir in accordance with a further aspect of the invention;

FIG. 7 is an exploded, detail view of the reservoir showing the inlet/syphon tube;

FIG. 8 is a vertical sectional view on line A-A of FIG. 6;

FIG. 9 is a view similar to FIG. 7 illustrating an alternative form of inlet/syphon tube; and,

FIG. 10 is a view similar to FIG. 8 illustrating the inlet/syphon tube of FIG. 9.

### DESCRIPTION OF PREFERRED EMBODIMENTS

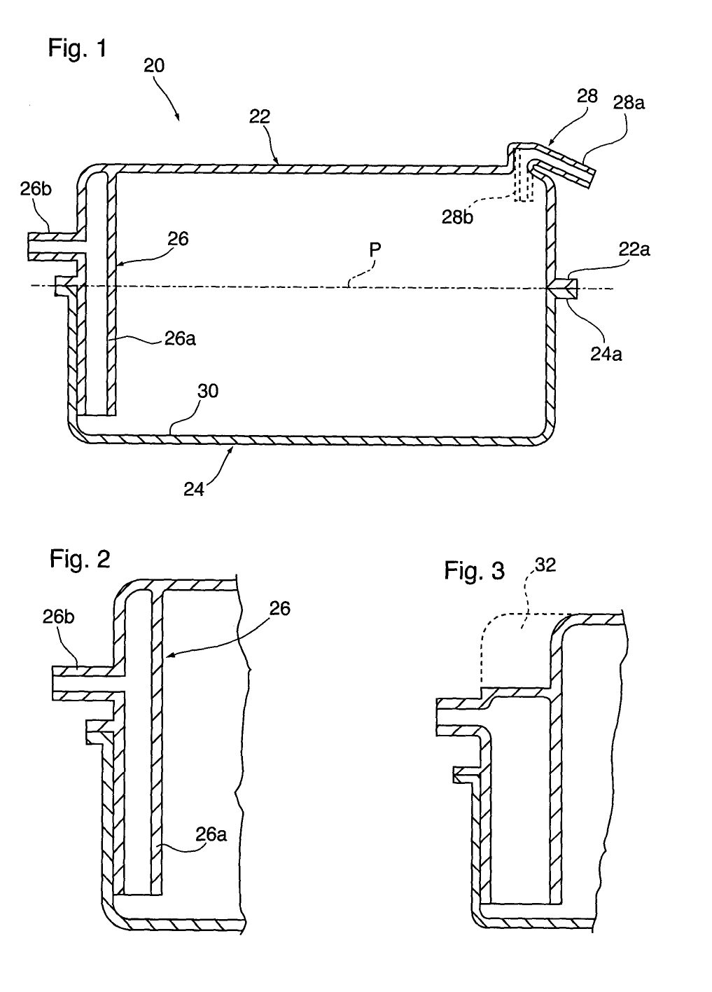

Referring first to FIG. 1, a coolant reservoir in accordance with the invention is generally designated by reference number 20 and is shown to include upper and lower molded sections 22 and 24 respectively that meet in a horizontal plane P of the reservoir. The two sections are formed with mating outwardly protruding flanges 22a and 24a respectively at which the two sections are welded or otherwise sealed together. The reservoir has an inlet/syphon tube generally indicated at 26 for connection to the engine cooling system, and an overflow outlet 28. A cap on the reservoir is not visible.

Referring now more particularly to FIG. 2, it can be seen that the inlet/syphon tube 26 is formed integrally as part of the upper molded section 20 and includes a portion 26a that extends downwardly to a location adjacent a bottom wall 30 of the reservoir, formed by part of the lower molded section 24. The inlet/outlet tube also includes a portion 26b that extends outwardly of the reservoir and opens to the exterior of the reservoir, through the upper molded section.

As the temperature of coolant in the engine cooling system increases, coolant will eventually flow through the inlet portion 26b and into the reservoir. When the temperature of the coolant drops sufficiently, coolant will return to the engine cooling system by way of the syphon provided by the inlet/syphon tube 26.

FIG. 3 is a view similar to FIG. 2 showing a shorter syphon, formed by a “core out” in the upper molded section indicated in dotted lines at 32.

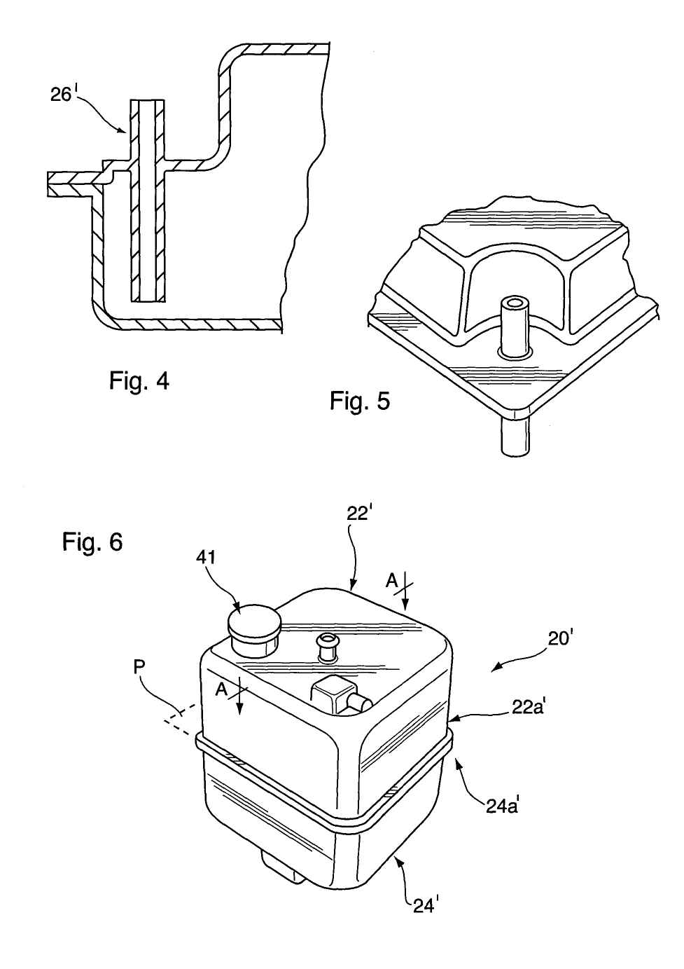

FIGS. 4 and 5 show a similar configuration of the upper reservoir section but in which the inlet/syphon tube is replaced by a plain tube 26′ that extends vertically through a wall portion of the upper housing part both outwardly and inwardly of the reservoir as best seen in FIG. 4. Tube 26′ is molded integrally with the upper housing part 22.

As mentioned previously, the reservoir also includes an outlet/overflow 28 that provides a safety feature for the extreme case in which the reservoir becomes completely filled by coolant. The outlet overflow 28 is also integrally formed as part of the upper reservoir housing section 20. During the injection molding process, a nozzle 28a is formed as part of the outlet 28. The outlet may also include a portion 28b indicated in broken lines, that extends inwardly of the reservoir. In some systems, slosh is a concern. Portion 28b may address that concern by acting as a baffle. Additional baffle elements or other functional features may be added to address specific design requirements.

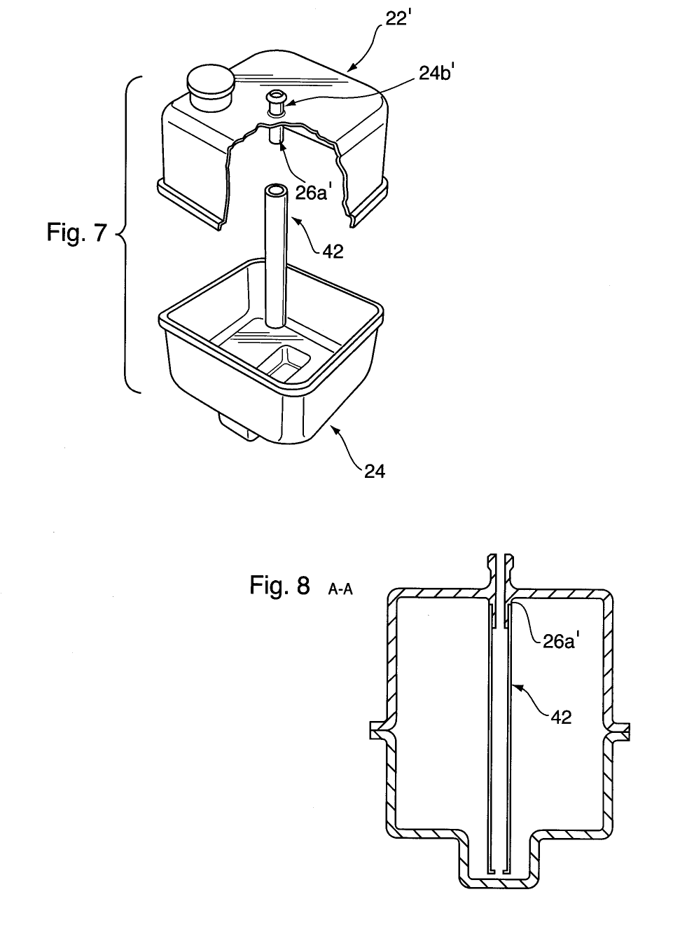

Reference will now be made to FIGS. 6 to 10 of the drawings, which illustrate a form of coolant reservoir that has a significantly greater overall height than the reservoir shown in FIGS. 1 to 5. As noted previously, in situations such as this, it may be difficult to mold an inlet/syphon tube in one piece with the upper molded section of the reservoir.

Primed reference numerals are used in FIGS. 6 to 8 to denote parts that correspond with parts shown in FIGS. 1 to 5.

The reservoir in FIGS. 6 to 10 is generally square in plan view and (as noted previously) is taller than the reservoir shown in the previous views. A cap on the reservoir is indicated at 41. In this embodiment, a portion only of the syphon tube is molded integrally with the upper molded section of the reservoir and extends both into and outwardly of the reservoir. The length of the syphon tube is extended beyond the integrally molded part 26a that extends into the reservoir by a syphon tube extension 42.

As shown in FIG. 8, extension 42 is a push fit over portion 26a of the syphon tube.

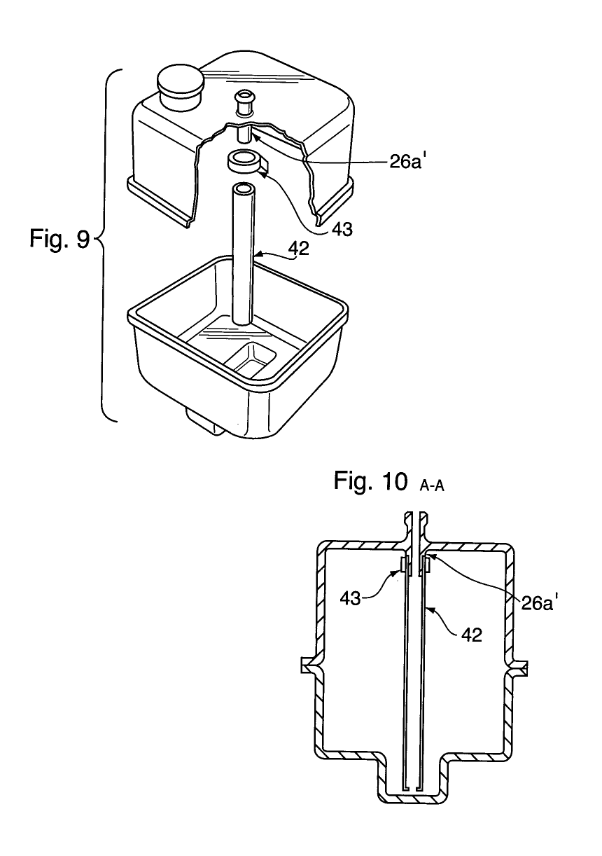

The embodiment shown in FIGS. 9 and 10 is essentially the same as the embodiment of FIGS. 6 to 8 except that the syphon tube is positively held in place on inlet tube portion 26a by means of a screw clamp 43.

It will be appreciated that the preceding description relates to particular preferred embodiments of the invention and that numerous modifications are possible within the broad scope of the invention. Some of those modifications have been indicated previously and others will be apparent to a person skilled in the art.

In the illustrated embodiments, the integrally molded syphon tube or portion thereof extends down from the upper one of the two plastic molded sections. While in general that may be the preferred configuration, it would be possible for the syphon tube to be molded integrally with the lower housing section. For example, in the embodiment of FIG. 3, the plane between the upper and lower molded sections could lie in the vicinity of the core out 32, below the top wall of the reservoir, in which case, the inlet/syphon tube would be integrally molded with the lower housing section.

1. A coolant reservoir for an internal combustion engine having a cooling system, the reservoir comprising at least two plastic molded sections that are sealed together to define an internal volume for receiving coolant, the reservoir having an inlet for connection to the cooling system and an outlet providing an overflow, wherein the inlet is defined by a syphon tube that extends downwardly from one of said molded sections into said internal volume, terminating adjacent to and spaced from a bottom wall of the reservoir at least a portion of the syphon tube being molded integrally with said one molded section and extending both into and outwardly of the reservoir, the syphon tube opening to the exterior of the reservoir through said one molded section.

2. A coolant reservoir as claimed in claim 1, wherein the syphon tube extends in one piece from said one molded section to a lower end adjacent to and spaced from the bottom wall of the reservoir.

3. A coolant reservoir as claimed in claim 1 which comprises two said plastic molded sections, namely an upper section and a lower section, the two sections being sealed together in a horizontal plane through the reservoir and the syphon tube being molded integrally with the upper plastic molded section.

4. A coolant reservoir as claimed in claim 1 or 2 wherein the said plastic molded sections are formed by injection molding.

5. A coolant reservoir as claimed in claim 1, further comprising an overflow outlet formed in said upper plastic molded section and including a portion that extends to the exterior of the reservoir and a portion that extends inwardly of the reservoir.

6. A coolant reservoir for an internal combustion engine having a cooling system, the reservoir comprising at least two plastic molded sections that are sealed together to define an internal volume for receiving coolant, the reservoir having an inlet for connection to the cooling system and an outlet providing an overflow, wherein the outlet is formed in said upper plastic molded section and includes a portion that extends to the exterior of the reservoir and a portion that extends inwardly of the reservoir.

7. A method of making a coolant reservoir for an internal combustion engine comprising the steps of:
injection molding at least two plastic molded sections designed to be sealed together to define an internal volume for receiving coolant, one of said sections including an inlet for connection to the engine cooling system and an outlet providing an overflow, wherein the inlet is defined by a syphon tube at least a portion of which is molded integrally with and extends downwardly from said one plastic molded section and opens to the exterior of the reservoir through said upper molded section; and,
sealing said plastic molded sections together to form the reservoir.
